(19) United States
(12) Patent Application Publication
(10) Pub. No.: US 2024/0294831 A1
(43) Pub. Date: Sep. 5, 2024

(54) SURFACTANT COMPOSITIONS INCLUDING HYDRAZIDE

(71) Applicant: Dow Global Technologies LLC, Midland, MI (US)

(72) Inventors: Cheng Shen, Shanghai (CN); Haiying Li, Shanghai (CN); Shaoguang Feng, Shanghai (CN); Jian Zou, Shanghai (CN); Zeyu Zhong, Shanghai (CN); Qianyuan Shan, Shanghai (CN)

(21) Appl. No.: 18/573,050

(22) PCT Filed: Oct. 6, 2021
(86) PCT No.: PCT/CN2021/122513

§ 371 Date: Dec. 21, 2023

(51) Int. Cl. C09K 23/00

(52) U.S. Cl. CPC C09K 23/018

(57) ABSTRACT

A surfactant composition includes 60 wt % or greater of a surfactant based on a total weight of the surfactant composition and 0.01 wt % to 1 wt % of a hydrazide antioxidant.

### BACKGROUND

### Field of the Disclosure

The present disclosure is directed to a surfactant composition and more specifically to a surfactant composition that comprises a hydrazide antioxidant.

### INTRODUCTION

Volatile organic compounds (“VOCs”) are compounds having a high vapor pressure. VOCs are introduced into products and compositions in a variety of manners. For example, the manufacturing of a product may leave VOCs in the product that will off gas over time. Additionally or alternatively, VOCs can be produced during storage of a product as a result of oxidation or exposure to elevated thermal conditions. Examples of VOCs include aldehydes, ketones, and various forms of acids. VOCs are typically emitted as gases from the product and may produce offensive odors and cause other issues. In view of these concerns, consumers and manufacturers have a heightened attention to the removal or reduction of VOCs in products.

Attempts have been made at addressing common VOCs. For example, World Intellectual Property Organization Publication 2018148898 (“the '898 publication”) discloses the use of polyurethane foams that exhibit reduced levels of formaldehyde and acetaldehyde emissions. The '898 publication discloses the use of antioxidants in an attempt to decrease VOCs. As can be seen in Tables 1 and 3 of the '898 publication, the use of the antioxidant alone has the effect of increasing all measured VOCs (i.e., formaldehyde, acetaldehyde, and acrolein) rather than decreasing the VOCs. In contrast to the '898 publication, Chinese patent number 107335320B (“the '320 patent”) discloses an odor and formaldehyde removing composition. The composition of the '320 patent utilizes an antioxidant, in the form of carbohydrazide, bound to graphene and titanium oxides to neutralize and trap formaldehyde. Carbohydrazide is one compound in a broader chemical class of hydrazides. Comparative example 9 of the '320 patent demonstrates that when carbohydrazide is removed from the graphene oxide-nano titanium dioxide compound that the formaldehyde reducing ability of the composition is minorly impacted. This result suggests that carbohydrazide has a minimal, if any, impact on the formaldehyde eliminating properties of the carbohydrazide modified graphene and titanium oxides.

In view of the foregoing, it would be surprising to discover a composition utilizing a hydrazide antioxidant compound and which exhibits not only a reduced concentration of aldehyde and ketone VOCs, but also ester, alcohol, and acid VOCs.

### SUMMARY OF THE DISCLOSURE

The inventors of the present application have discovered a composition that uses a hydrazide antioxidant compound and which exhibits not only a reduced concentration of aldehyde and ketone VOCs, but also ester, alcohol, and acid VOCs. The inventors of the present application have discovered that the incorporation of 0.01 weight percent (“wt %”) to 1 wt % of a hydrazide antioxidant into a surfactant composition comprising 60 wt % or greater of a surfactant reduces aldehyde, ketone, ester, alcohol and acid VOCs simultaneously. Such a result is surprising in that despite the relatively minor amount of hydrazide antioxidant, a large impact on total VOCs present in the surfactant composition is achieved. Further, given the prior art demonstrated tendency of antioxidants to increase VOCs or to exhibit a minor impact on their presence such an effect is surprising. The VOC reducing capability of hydrazide antioxidants is advantageous in that it allows for the production and distribution of surfactant compositions that will not significantly contribute to a downstream product's total VOC content.

The present invention is particularly useful in coating, cleaning, and adhesive applications.

According to a first feature of the present disclosure, a surfactant composition comprises 60 wt % or greater of a surfactant based on a total weight of the surfactant composition and 0.01 wt % to 1 wt % of a hydrazide antioxidant.

According to a second feature of the present disclosure, the surfactant is an alkoxylated surfactant.

According to a third feature of the present disclosure, the surfactant is an ethoxylated non-ionic surfactant.

According to a fourth feature of the present disclosure, the surfactant is a non-ionic surfactant and comprises 8 or 9 moles of ethylene oxide on average.

According to a fifth feature of the present disclosure, the surfactant has structure (I) and n of structure (I) is 3 to 11.

According to a sixth feature of the present disclosure, the surfactant has structure (II), wherein x of Structure (II) is 2 to 8 and y of structure (II) is 3 to 40.

According to a seventh feature of the present disclosure, the surfactant composition comprises 75 wt % or greater of the surfactant based on the total weight of the surfactant composition.

According to an eighth feature of the present disclosure, the surfactant composition comprises from 0.01 wt % to 0.5 wt % of the hydrazide antioxidant based on the total weight of the surfactant composition.

According to a ninth feature of the present disclosure, the hydrazide antioxidant is carbohydrazide.

According to a tenth feature of the present disclosure, the surfactant composition consists essentially of the surfactant, water and the carbohydrazide.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); IEC refers to International Electrotechnical Commission; EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise specified.

As used herein, Chemical Abstract Services registration numbers (“CAS #”) refer to the unique numeric identifier as most recently assigned as of the priority date of this document to a chemical compound by the Chemical Abstracts Service.

### Surfactant Compositions

The present disclosure is directed to a surfactant composition. The surfactant composition includes a surfactant and a hydrazide antioxidant. According to various examples, the surfactant composition consists essentially of the surfactant and the hydrazide antioxidant meaning that it includes no other compounds that materially affect the properties of the surfactant composition. As explained in greater detail below, the introduction of the hydrazide antioxidant aids in reducing and/or eliminating a variety of VOCs from the surfactant composition such that the surfactant composition does not significantly contribute to the VOC content of downstream applications.

### Surfactant

As stated above, the surfactant composition comprises the surfactant. As used herein, the term “surfactant” means a compound that lowers the interfacial tension between two immiscible phases of dissimilar chemistry. The surfactant may be ionic or non-ionic. The surfactant may be alkoxylated with one or more ethylene oxide (i.e., ethoxylated), propylene oxide (i.e., propoxylated) and/or butylene oxide (i.e., butoxylated) components. The surfactant may have Structure (I)

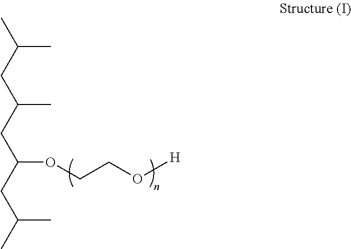

wherein n of structure (I) is 3 or greater, or 4 or greater, or 5 or greater, or 6 or greater, or 7 or greater, or 8 or greater, or 9 or greater, or 10 or greater, while at the same time, 11 or less, or 10 or less, or 9 or less, or 8 or less, or 7 or less, or 6 or less, or 5 or less, or 4 or less. The variable “n” describes the average molar units of oxyethylene in structure (I). As defined herein, the n value is tested and determined by Proton Nuclear Magnetic Resonance Spectroscopy and Carbon-13 Nuclear Magnetic Resonance Spectroscopy. The surfactant may have Structure (II)

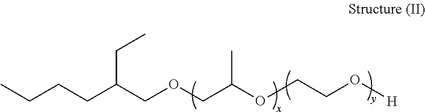

wherein y of structure (II) is 3 or greater, or 4 or greater, or 5 or greater, or 10 or greater, or 15 or greater, or 20 or greater, or 25 or greater, or 30 or greater, or 35 or greater, while at the same time, 40 or less, or 35 or less, or 30 or less, or 25 or less, or 20 or less, or 15 or less, or 10 or less, or 5 or less, or 4 less. X of structure (II) is 2 or greater, or 3 or greater, or 4 or greater, or 5 or greater, or 6 or greater, or 7 or greater, while at the same time, 8 or less, or 7 or less, or 6 or less, or 5 or less, or 4 or less, or 3 or less. The variable “x” describes the average molar units of oxypropylene utilized in structure (II) and the variable “y” describes the average molar units of oxyethylene in structure (II). As defined herein, the x and y values are tested and determined by Proton Nuclear Magnetic Resonance Spectroscopy and Carbon-13 Nuclear Magnetic Resonance Spectroscopy. The surfactant may be a blend of surfactants such as Structure (I), Structure (II) and/or other surfactants.

The surfactant composition comprises 60 wt % or greater of the surfactant based on the total weight of the surfactant composition. For example, the surfactant composition may comprise 60 wt % or greater, or 61 wt % or greater, or 62 wt % or greater, or 63 wt % or greater, or 64 wt % or greater, or 65 wt % or greater, or 66 wt % or greater, or 67 wt % or greater, or 68 wt % or greater, or 69 wt % or greater, or 70 wt % or greater, or 71 wt % or greater, or 72 wt % or greater, or 73 wt % or greater, or 74 wt % or greater, or 75 wt % or greater, or 76 wt % or greater, or 77 wt % or greater, or 78 wt % or greater, or 79 wt % or greater, or 80 wt % or greater, or 81 wt % or greater, or 82 wt % or greater, or 83 wt % or greater, or 84 wt % or greater, or 85 wt % or greater, or 86 wt % or greater, or 87 wt % or greater, or 88 wt % or greater, or 89 wt % or greater, or 90 wt % or greater, or 91 wt % or greater, or 92 wt % or greater, or 93 wt % or greater, or 94 wt % or greater, or 95 wt % or greater, or 96 wt % or greater, or 97 wt % or greater, or 98 wt % or greater, or 99 wt % or greater, while at the same time, 99.98 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less, or 90 wt % or less, or 89 wt % or less, or 88 wt % or less, or 87 wt % or less, or 86 wt % or less, or 85 wt % or less, or 84 wt % or less, or 83 wt % or less, or 82 wt % or less, or 81 wt % or less, or 80 wt % or less, or 79 wt % or less, or 78 wt % or less, or 77 wt % or less, or 76 wt % or less, or 75 wt % or less, or 74 wt % or less, or 73 wt % or less, or 72 wt % or less, or 71 wt % or less, or 70 wt % or less, or 69 wt % or less, or 68 wt % or less, or 67 wt % or less, or 66 wt % or less, or 65 wt % or less, or 64 wt % or less, or 63 wt % or less, or 62 wt % or less, or 61 wt % or less based on the total weight of the surfactant composition.

### Hydrazide Antioxidant

The surfactant composition comprises a hydrazide antioxidant. As defined herein, a “hydrazide antioxidant” is compound comprising a hydrazide functional group. Examples of the hydrazide antioxidant include carbohydrazide, acethydrazide, propanohydrazide, malonic dihydrazide, adipic dihydrazide, sebacic dihydrazide, succinic dihyrazide, tartaric dihydrazide diphenylhydrazide, other hydrazides and combinations thereof. The surfactant composition comprises 0.01 wt % to 1.00 wt % of the hydrazide antioxidant. For example, the surfactant composition comprises 0.01 wt % or greater, or 0.05 wt % or greater, or 0.10 wt % or greater, or 0.20 wt % or greater, or 0.30 wt % or greater, or 0.40 wt % or greater, or 0.50 wt % or greater, or 0.60 wt % or greater, or 0.70 wt % or greater, or 0.80 wt % or greater, or 0.90 wt % or greater, while at the same time, 1.00 wt % or less, or 0.90 wt % or less, or 0.80 wt % or less, or 0.70 wt % or less, or 0.60 wt % or less, or 0.50 wt % or less, or 0.40 wt % or less, or 0.30 wt % or less, or 0.20 wt % or less, or 0.10 wt % or less of the hydrazide antioxidant based on the total weight of the surfactant composition.

### EXAMPLES

### Materials

The following materials were used in the examples.

Surfactant 1 is Structure (II) with an x of 5 and a y of 9 and having a CAS number of 64366-70-7. Surfactant 1 has 99 wt % or greater actives and is available from The Dow Chemical Company, Midland, MI, USA.

Surfactant 2 is Structure (I) with an n of 3 having a CAS number of 60828-78-6. Surfactant 2 is a 90 wt % actives and 10 wt % aqueous composition and is available from The Dow Chemical Company, Midland, MI, USA.

CBH is a 5 wt % carbohydrazide in water solution. Carbohydrazide has a CAS number of 497-18-7 and is available from Sigma-Aldrich., St. Louis, Missouri.

### Sample Preparation and Testing

The comparative examples (“CE”) and inventive examples (“IE”) were prepared by first combining the designated constituents in a sample container. The container was then placed on a shaking table for two hours and 300 revolutions per minute. All samples exhibited a homogenous appearance at the end of shaking. CE1, CE2, IE1, and IE2 were heated to 54° C. for twenty-four hours before headspace gas chromatography-mass spectrometry (“HS_GCMS”) analysis was performed on the samples. IE3-IE6 were aged at approximately 23° C. for 48 hours. All control examples were 100 wt % surfactant 1 or surfactant 2 and left at approximately 23° C. while the other samples were aging.

An Agilent 7890A Gas chromatograph, Agilent 5975C mass spectrometer and an Agilent 7697A headspace auto sampler were utilized to analyze the headspace of the containers. The Gas chromatograph column was an Agilent DB-5 MS having a 30 mm×320 μm×1 μm dimension. The carrier gas used was helium at 1.5 mL/minute constant flow. The gas chromatograph oven program was 50° C., hold 5 minutes, 10° C./minute ramp to 250° C., hold 3 minutes. The Gas chromatograph was set in scan mode with a source temperature of 230° C., a MS Quad temperature of 150° C., and an acquisition scan mode looking for masses from 29 Daltons to 400 Daltons. The headspace oven was heated to 130° C. for 15 minutes. The HS GCMS was performed on 20-30 mg of sample that was put into 20 mL headspace vials for analysis. All samples were prepared for duplicate, and the average results are provided. All VOCs were semi-quantified using toluene as standard. An aliquot of 2.0 μg of toluene was injected into headspace vial, and toluene peak area was used for semi-quantification.

### Results

Table 1 provides composition data for the samples including surfactant 1 and surfactant 2. In order to ensure proper removal rate calculation, each set of experiments had a control sample to establish baseline VOC concentrations from which the removal rate is calculated by dividing the total impurity of the example by the total impurity of the control. In the tables, the entry “ND” means not detected and “<LOQ” designates that a particular VOC concentration was sufficiently low that it could not be reported with confidence. The reduction of VOCs is calculated by subtracting the quotient of total VOCs of a sample by the control total VOCs from 1 and multiplying the result by 100. The VOC concentrations are provided in parts per million (“PPM”). Tables 2 and 3 provide testing results of the VOCs present in the controls and examples.

TABLE 1

| | Surfactant 1 | Surfactant 2 | CBH |
|---|---|---|---|
| Ex | (wt %) | (wt %) | (wt %) |
| Control 1 | 100 | | |
| CE1 | 100 | | |
| IE1 | 99.95 | | 0.05 |
| Control 2 | | 100 | |
| CE2 | | 100 | |
| IE2 | | 99.95 | 0.05 |
| Control 3 | 100 | | |
| IE3 | 99.99 | | 0.01 |
| IE4 | 99.95 | | 0.05 |
| Control 4 | | 100 | |
| IE4 | | 99.99 | 0.01 |
| IE5 | | 99.95 | 0.05 |

TABLE 2

| | Control 1 | CE1 | IE1 |
|---|---|---|---|
| VOC | (ppm) | (ppm) | (ppm) |
| 4-heptanone | 1.2 | 1.7 | <LOQ |
| 3-heptanone | 4.1 | 4.9 | 1.2 |
| Hexananl, 2- | 40.2 | 40.5 | 1.1 |
| ethyl | | | |
| 2-heptanone | <LOQ | <LOQ | <LOQ |
| 1,2-propanediol, | 2.1 | 2.0 | <LOQ |
| 1-acetate | | | |
| Carbonic acid, | 9.4 | 9.4 | 2.9 |
| 2-ethylhexyl | | | |
| isobutyl ester | | | |
| Acetic acid | 61.9 | 57.1 | 11.6 |
| 1,2-ethanediol, | 3.5 | 5.0 | <LOQ |
| diacetate | | | |
| Total VOCs | 122.4 | 120.6 | 16.8 |
| Reduction (%) | | | 86.1 |

TABLE 3

| | Control 2 | CE2 | IE2 |
|---|---|---|---|
| VOC | (ppm) | (ppm) | (ppm) |
| Acetone and | 17.4 | 13.3 | ND |
| butanal | | | |
| Methyl isobutyl | 18.3 | 16.1 | 4.1 |
| ketone | | | |
| Heptane, 2,4- | 14.3 | 12.4 | 5.2 |
| dimethyl- | | | |
| Ethanol, 2- | 4.3 | 3.0 | 0.7 |
| methoxyl- | | | |
| 2-heptanone, | 3.9 | 2.9 | 0.9 |
| 4,6-dimethyl- | | | |
| Hydrocarbon | 17.2 | 14.1 | 7.5 |
| alcohol | | | |
| 4-nonanone, | 162.6 | 143.8 | 43.9 |
| 2,6,8-trimethyl- | | | |
| Acetic acid | 137.7 | 132.9 | 28.2 |
| Total VOCs | 375.7 | 338.5 | 90.5 |
| Reduction (%) | | | 75.9 |

Referring now to Tables 1-3, it is evident that the introduction of a hydrazide antioxidant to either surfactant 1 or surfactant 2 reduces the total VOC concentration of the surfactant composition. IE1 compared to CE1 and control 1 demonstrates that the hydrazide antioxidant is able to reduce over 86% of VOCs initially present in surfactant 1 and resists the formation of new VOCs after heat aging. IE2 compared to CE2 and control 2 demonstrates that the hydrazide antioxidant is able to reduce over 75% of VOCs initially present in surfactant 2 and resists the formation of new VOCs after heat aging. IE1 and IE2 demonstrate that the use of the hydrazide antioxidant effectively reduces VOCs present in a variety of types of surfactants and surfactant compositions. Further demonstrated by Tables 1-3 is that the hydrazide antioxidant is particularly effective at reducing ketone and aldehyde-based VOCs.

Referring now to Table 4 provided is aldehyde VOC removal data for IE3-IE6.

TABLE 4

| | | | | | Total | |
|---|---|---|---|---|---|---|
| | Formaldehyde | Acetaldehyde | Propionaldehyde | Acrolein | VOC | Removal |
| Ex. | (ug/m³) | (ug/m³) | (ug/m³) | (ug/m³) | (ug/m³) | rate |
| Control 3 | 5759 | 183147 | 2200 | 280 | 191386 | |
| IE3 | 1217 | 50093 | 802 | 98 | 52210 | 72.72% |
| IE4 | 155 | 7841 | 76 | 18 | 8090 | 95.77% |
| Control 4 | 4654 | 8518 | 109 | 11 | 13292 | |
| IE5 | 239 | 682 | 14 | 2 | 937 | 92.95% |
| IE6 | 77 | 86 | 2 | 3 | 168 | 98.74% |

Table 4 demonstrates that hydrazide antioxidant is an effective remover of aldehyde-based VOCs for both types of surfactants tested. Each of IE4-6 provide greater than 90% reduction of VOCs and IE3 still provides acceptable VOC reduction of greater than 70%.

What is claimed is:

1. A surfactant composition, comprising:
60 wt % or greater of a surfactant based on a total weight of the surfactant composition; and
0.01 t % to 1 wt % of a hydrazide antioxidant.

2. The surfactant composition of claim 1, wherein the surfactant is an alkoxylated surfactant.

3. The surfactant composition of claim 2, wherein the surfactant is an ethoxylated non-ionic surfactant.

4. The surfactant composition of claim 2, wherein the surfactant is a non-ionic surfactant and comprises 8 or 9 moles of ethylene oxide on average.

5. The surfactant composition of claim 1, wherein the surfactant has structure (I) 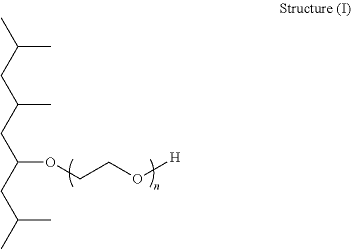
wherein n of structure (I) is 3 to 11.

6. The surfactant composition of claim 1, wherein the surfactant has structure (II) 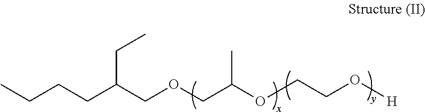
wherein x of structure (II) is 2 to 8 and y of structure (II) is 3 to 40.

7. The surfactant composition of claim 1, wherein the surfactant composition comprises 75 wt % or greater of the surfactant based on the total weight of the surfactant composition.

8. The surfactant composition of claim 7, wherein the surfactant composition comprises from 0.01 wt % to 0.5 wt % of the hydrazide antioxidant based on the total weight of the surfactant composition.

9. The surfactant composition of claim 1,
wherein the hydrazide antioxidant is carbohydrazide.

10. The surfactant composition of claim 9, wherein the surfactant composition consists essentially of the surfactant, water and the carbohydrazide.
